(19) United States
(12) Patent Application Publication
(10) Pub. No.: US 2026/0166937 A1
(43) Pub. Date: Jun. 18, 2026

(54) COMPLIANT MECHANISM SUSPENSION SYSTEM

(71) Applicant: DISNEY ENTERPRISES, INC., Burbank, CA (US)

(72) Inventors: Dayne Christopher Luekenga, Winter Garden, FL (US); Timothy Joseph Conway, Clermont, FL (US); John Douglas Smith, Orlando, FL (US); Miguel Cabada, Winter Springs, FL (US)

(21) Appl. No.: 18/980,571

(22) Filed: Dec. 13, 2024

(51) Int. Cl. B60G 5/02

(52) U.S. Cl. CPC B60G 5/02; B60G 2300/10

(57) ABSTRACT

A suspension system may include a plate, a frame extending at least partially around the plate, and a resilient member extending between to connect the plate to the frame. The resilient member may be configured to resiliently deform to allow a movement of the plate relative to the frame. The frame may be associated with a chassis configured to couple a track vehicle to a track. A pair of plates may define a rotation axis for a wheel configured to traverse along the track. Resilient members may extend between the pair of plates and the frame. A suspension part formed as a single monolithic component may include a first plate, a second plate, and a resilient member extending between the first plate and the second plate, the resilient member configured to resiliently deform to allow a movement of the first plate relative to the second plate.

### FIELD

The present application relates to wheel mounted suspension, such as a suspension system for tracked rides, attractions, or transportation systems.

### BACKGROUND

Components of a wheel mounted suspension wear, such as due to movement of the system used for guidance and breakdown of the components used for force. Typical applications include automobiles, bikes, rollercoasters, and any vehicle with a suspension loaded wheel. These traditional suspension systems have high wear and maintenance costs, as well as require additional space to house the components.

Therefore, a need exists for systems and methods that address the concerns above or at least offers an alternative to existing solutions.

### BRIEF SUMMARY

In one example, a suspension system includes a plate, a frame extending at least partially around the plate, and a resilient member extending between to connect the plate to the frame, wherein the resilient member is configured to resiliently deform to allow a movement of the plate relative to the frame.

Optionally, the resilient member is configured to bend to allow the movement.

Optionally, the resilient member defines a spring constant for the movement.

Optionally, the movement is a translational movement of the plate relative to the frame.

Optionally, the suspension system includes a second resilient member extending between to connect the plate to the frame, wherein the resilient member and the second resilient member are provided on opposite sides of the plate.

Optionally, the suspension system includes a chassis configured to couple a track vehicle to a track, wherein the frame is coupled to the chassis.

In another example, a suspension part formed as a single monolithic component includes a first plate, a second plate, and a resilient member extending between the first plate and the second plate, wherein the resilient member is configured to resiliently deform to allow a movement of the first plate relative to the second plate.

Optionally, the first plate and the second plate are coplanar in a plane. The resilient member may be configured to resiliently deform to allow a movement of the first plate within the plane. The resilient member may be configured to limit a second movement of the first plate out of the plane.

Optionally, the first plate defines a rotation axis for a wheel and the second plate is configured to be fixed to a chassis.

Optionally, an engagement of the first plate with the second plate defines a stop position.

Optionally, a suspension system includes the suspension part. The suspension system may include a second suspension part formed as a second single monolithic component. The second suspension part may include a third plate, a fourth plate, and a second resilient member extending between the third plate and the fourth plate. The second resilient member may be configured to resiliently deform to allow a movement of the third plate relative to the fourth plate. The suspension system may include at least one boss coupling the suspension part to the second suspension part, the at least one boss spacing the suspension part from the second suspension part to define a space for receiving a wheel.

In another example, a suspension system includes a chassis configured to couple a track vehicle to a track, a pair of plates defining a rotation axis for a wheel configured to traverse along the track, a frame associated with the chassis and extending adjacent the pair of plates, and resilient members extending between the pair of plates and the frame, wherein the resilient members are configured to resiliently deform to allow a movement of the pair of plates relative to the frame.

Optionally, the frame includes a first frame component coupled to a first plate of the pair of plates, a second frame component coupled to a second plate of the pair of plates, and at least one third frame component spacing the first frame component away from the second frame component to define a space for receiving the wheel. The resilient members may include a first set of resilient members and a second set of resilient members. The first set of resilient members may extend between the first frame component and the first plate. The second set of resilient members may extend between the second frame component and the second plate.

Optionally, the pair of plates are configured to couple to an axle of the wheel.

Optionally, the chassis limits a first movement of the track vehicle relative to the track, wherein the movement is a second movement perpendicular to the first movement.

Optionally, the movement is perpendicular to the rotation axis.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates an example attraction including a suspension system.

FIG. 2 illustrates a top perspective view of an example suspension system.

FIG. 3 illustrates a bottom perspective view of the suspension system of FIG. 2.

FIG. 4 illustrates a side view of the suspension system of FIG. 2.

FIG. 5 illustrates a cross-sectional view of the suspension system of FIG. 2.

FIG. 6 illustrates a perspective view of an example suspension part.

FIG. 7 illustrates another example suspension system.

FIG. 8 illustrates another example suspension system.

### DETAILED DESCRIPTION

The disclosed systems provide a compliant mechanism plate design that eliminates traditional components that wear when used for guidance and force balance, such as to suspend a track vehicle about a track or rail. Using geometry and material properties, a flexible (e.g., monolithic) plate can absorb impact loading and provide wheel guidance in a compact component. The systems provided herein are compact, such as providing a single component that performs multiple functions found in traditional suspension applications. For instance, traditional applications may require separate components for wheel movement and for suspension and load balance. Traditional designs also have components requiring replacement and lubrication. The disclosed systems remove some of these wear components, replacing them, in some examples, with a singular, more compact plate. The compliant mechanism suspension systems disclosed herein significantly reduce the need for maintenance and reduce maintenance costs. The provided systems also reduce the number of components required, such as allowing for wheel suspension to be incorporated into a support bracket.

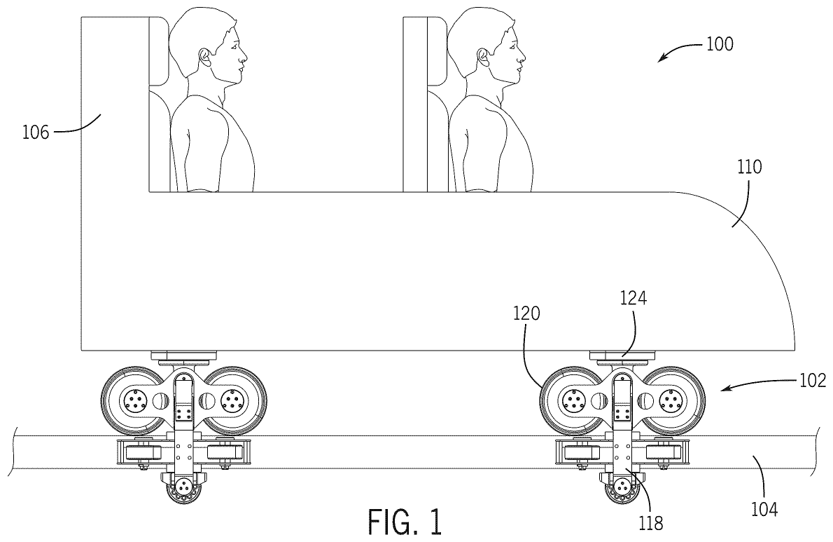

Turning to the figures, FIG. 1 illustrates an example track vehicle system 100 including a suspension system 102. The track vehicle system 100 includes a track 104 and a track vehicle 106 positioned on, coupled to, or otherwise engaged with the track 104. The track vehicle system 100 may be a crane system, a gantry system, a people or object mover, an attraction or ride, a monorail, a subway or other transportation system, or another system having a vehicle or other component that follows a track or guide. As one example, FIG. 1 illustrates a ride system including a ride vehicle for an attraction or ride. In such examples, the track vehicle 106 is configured to carry one or more passengers or guests, such as through an attraction or ride, e.g., train, roller coaster, or other tracked vehicles. For example, the track vehicle 106 may include a cockpit 110 to house of receive one or more passengers, guests, animals, or objects. The track vehicle 106 may have different configurations based on applicable restrictions, ride or attraction theme, desired guest experience, or the like. For example, the track vehicle 106 may include an open or closed cockpit, be sized and shaped to mimic a desired vehicle or theme (e.g., air vehicle, water vehicle, ground vehicle, movie or show vehicle, etc.), be realistic or unrealistic (e.g., imaginary), etc., but generally be configured to receive one or more guests. For instance, the cockpit 110 may be configured as a compartment that includes a seating area to allow one or more guests to sit within the track vehicle 106. Additionally, or alternatively, the cockpit 110 or compartment may include a standing or other position configuration for guests.

The track vehicle 106 may include one or more features to support the track vehicle 106 on the track 104. For example, the suspension system 102 may include a chassis 118, such as multiple chassis, configured to couple the track vehicle 106 to the track 104. The chassis 118 may roll, slide, or otherwise traverse along the track 104, such as via wheels, sliders, or other components, as detailed below. For example, the chassis 118 may support one or more wheels or wheel assemblies 120. The chassis 118 may include a coupler 124 configured to secure the chassis 118 to the track vehicle 106. For instance, the coupler 124 may include a flange secured to the cockpit 110 via fasteners.

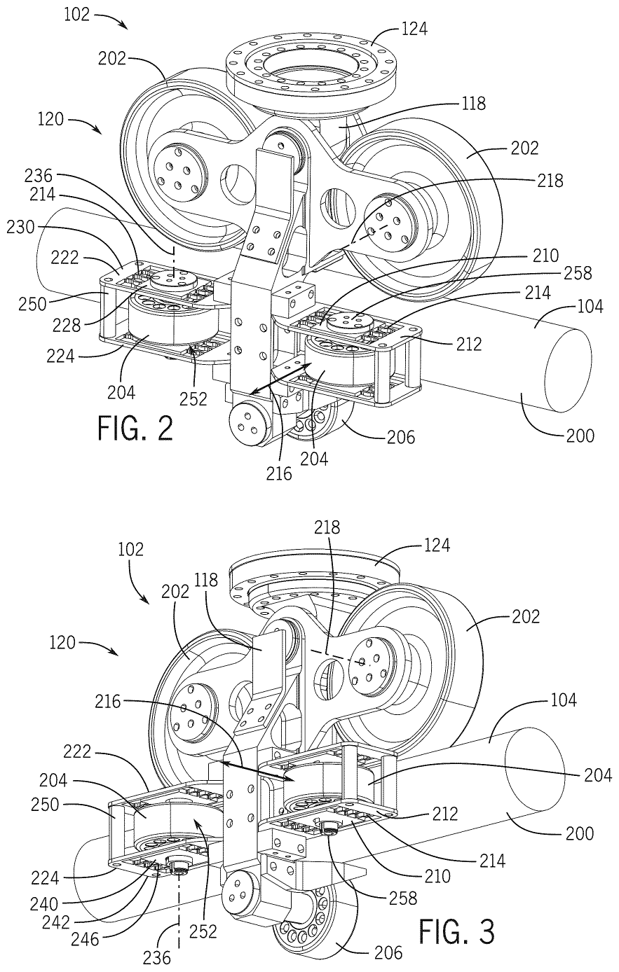

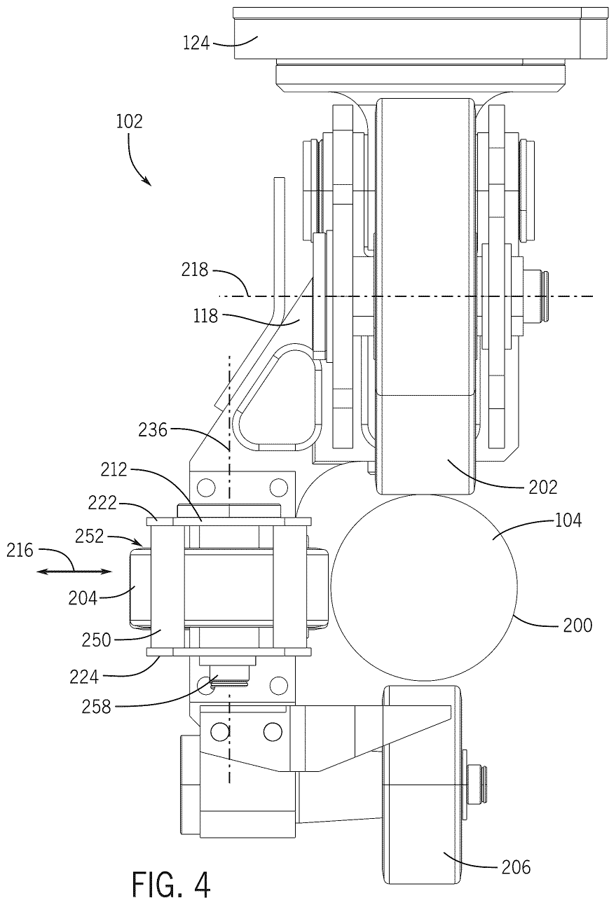

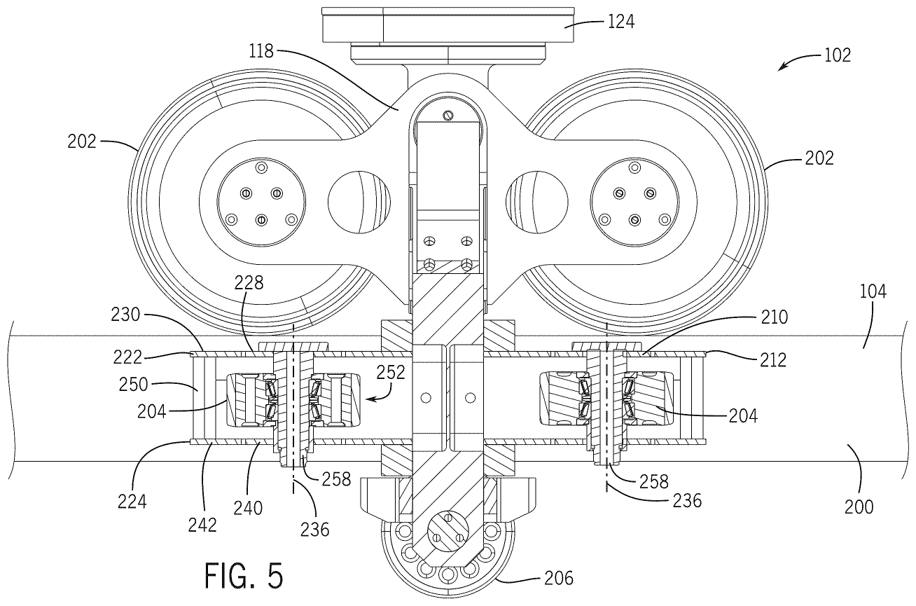

FIG. 2 illustrates a top perspective view of the suspension system 102. FIG. 3 illustrates a bottom perspective view of the suspension system 102. FIG. 4 illustrates a side view of the suspension system 102. FIG. 5 illustrates a cross-sectional view of the suspension system 102. Referring to FIGS. 2-5, the track 104 may include a rail 200, such as a tube. The chassis 118 may support one or more load wheels 202, guide wheels 204, and upstop wheels 206 coupled to the rail 200. The load wheels 202 may bear the load of the track vehicle 106 on the track 104, such as to support the weight of the track vehicle 106 and other forces biasing the track vehicle 106 towards the track 104 (e.g., vertical downward g-forces, etc.). The guide wheels 204 may be mounted perpendicular to the load wheels 202, such as on either the inside or the outside of the rail 200, depending on the type of track 104. The guide wheels 204 may steer the track vehicle 106 to follow the track 104. The upstop wheels 206 may be positioned opposite the load wheels 202 (e.g., under the rail 200) to limit or prevent the track vehicle 106 from coming off the rail 200, such as over hills, while the track vehicle 106 is inverted, etc.

As shown, the suspension system 102 may include multiple (e.g., two) load wheels 202, multiple (e.g., two) guide wheels 204, and one upstop wheel 206, although other configurations are contemplated based on track and/or track vehicle configuration. Each wheel may be configured based on a desired characteristic or expected load. For example, the load wheels 202 may have a greater diameter than the guide wheels 204 and upstop wheel 206, such as for ride characteristics and/or load requirements. In some examples, the guide wheels 204 and upstop wheel 206 may be similar or identical, such as to allow interchangeability for ease of assembly and maintenance.

In some examples, the guide wheels 204 may be biased (e.g., spring-loaded) against the sides of the track 104. In such examples, a biasing force may maintain contact of the guide wheels 204 with the side of the rail 200. Such configurations may limit undesired lateral slop or roughness (e.g., banging) as the track vehicle 106 traverses the track 104. For instance, the biasing force may limit shuffling of the track vehicle 106 through turns and smooth out the ride experience. The biasing force may also provide a suspension action for the track vehicle 106, such as to smooth out lateral movement of the track vehicle 106 relative to the rail 200. The biasing force and/or suspension action may be provided using various configurations.

As one example configuration, the suspension system 102 may include a plate 210 and a frame 212 extending at least partially around the plate 210. The plate 210 may rotatably support a guide wheel 204, and the frame 212 may be coupled to the chassis 118. A resilient member 214 (e.g., one or more resilient members 214, multiple resilient members 214; hereinafter “resilient members” without intent to limit to multiple resilient members, i.e., “resilient members” may be interpreted as multiple resilient members 214 or a single resilient member 214) may extend between to connect the plate 210 to the frame 212. The resilient members 214 may be configured to resiliently deform to allow a movement 216 (e.g., a translational movement) of the plate 210 relative to the frame 212. For example, the resilient members 214 may be configured to bend to allow the movement 216. In other implementations, the resilient members 214 may define a spring constant for the movement 216. In some examples, resilient members 214 may be defined on opposite sides of the plate 210.

In examples, the chassis 118 may limit a first movement (e.g., a vertical movement) of the track vehicle 106 relative to the track 104, such as via engagement of load wheels 202 or upstop wheel 206 with the rail 200. In such examples, the resilient members 214 may allow a second movement of the plate 210 (e.g., a lateral movement, movement 216) perpendicular to the first movement, such as via compliant deformation of the resilient members 214 while the guide wheels 204 steer the track vehicle 106 along the rail 200. In examples, a load wheel 202 may rotate around an axis 218, and the movement 216 may be parallel to the axis 218. Besides movement 216, the resilient members 214 may limit movement of the plate 210 in other directions (e.g., vertically, in a direction parallel to the first movement, etc.).

As another example configuration, the suspension system 102 may include a first suspension part 222, a second suspension part 224, or a combination thereof, supporting a guide wheel 204. For instance, the first suspension part 222 and/or second suspension part 224 may rotatably support a guide wheel 204 adjacent the rail 200. Referring to FIG. 2, the first suspension part 222 may include a first plate 228 and a second plate 230. The first plate 228 may define a rotation axis 236 for the guide wheel 204. The second plate 230 may be fixed to the chassis 118. The resilient members 214 may extend between the first plate 228 and the second plate 230. The resilient members 214 may be configured to resiliently deform to allow movement (e.g., movement 216) of the first plate 228 relative to the second plate 230. The movement 216 may be perpendicular to the rotation axis 236. In some examples, the first plate 228 and the second plate 230 may be coplanar (e.g., in a plane). In such examples, the resilient members 214 may be configured to resiliently deform to allow movement of the first plate 228 within the plane, such as to accommodate movement 216 and provide a suspension action for the chassis 118 along the rail 200. In addition, the resilient members 214 may be configured to limit movement of the first plate 228 out of the plane, as detailed below.

Referring to FIG. 3, the second suspension part 224 may include a third plate 240 and a fourth plate 242. The third plate 240 may define the rotation axis 236, such as in combination with the first plate 228. The fourth plate 242 may be fixed to the chassis 118, such as opposite the guide wheel 204. Second resilient members 246 may extend between the third plate 240 and the fourth plate 242. The second resilient members 246 may be similar, if not identical, to the resilient members 214. For example, the second resilient members 246 may be configured to resiliently deform to allow a movement (e.g., movement 216) of the third plate 240 relative to the fourth plate 242, such as in a manner similar to the movement of the first plate 228 relative to the second plate 230.

Referring to FIGS. 2-3, the suspension system 102 may include bosses 250 coupling the first suspension part 222 to the second suspension part 224. For example, the bosses 250 may couple the second plate 230 to the fourth plate 242. In examples, the second and fourth plates 230, 242 may be coupled to the chassis 118 at one end and coupled to each other at an opposite end via the bosses 250. In examples, the bosses 250 may space the first suspension part 222 from the second suspension part 224 to define a space 252 for receiving the guide wheel 204.

As another example configuration, the suspension system 102 may include a pair of plates defining a rotation axis for a wheel configured to ride along the track 104. For instance, the first plate 228 and the third plate 240 may define the rotation axis 236 for guide wheel 204, such as configured to couple to an axle 258 of the guide wheel 204. The frame 212 may be associated with the chassis 118 and extend adjacent the pair of plates. For instance, the frame 212 may be coupled to the chassis 118, or the chassis 118 may define the frame 212 itself. In some examples, the frame 212 may be defined by the second plate 230, the fourth plate 242, and the bosses 250. Resilient members (e.g., resilient members 214, second resilient members 246) may extend between the pair of plates and the frame 212. In such examples, the resilient members 214, 246 may be configured to resiliently deform to allow a movement of the pair of plates relative to the frame 212 (e.g., movement 216).

In examples, the frame 212 may include a first frame component and a second frame component. The first frame component may be coupled to a first plate of the pair of plates, such as the second plate 230 coupled to first plate 228. The second frame component may be coupled to a second plate of the pair of plates, such as the fourth plate 242 coupled to the third plate 240. In such implementations, the resilient members may extend between the first frame component and the first plate 228, and the second resilient members 246 may extend between the second frame component and the second plate 230. In examples, the frame 212 may include a third frame component (e.g., bosses 250) spacing the first frame component away from the second frame component to define the space 252 for receiving guide wheel 204.

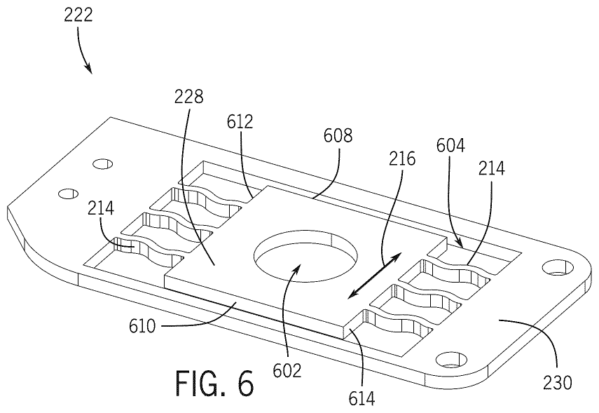

FIG. 6 illustrates a perspective view of an example suspension part, such as first suspension part 222. Although described with reference to first suspension part 222, the second suspension part 224 may include similar features. Thus, the description below may be applicable to the first suspension part 222 and/or the second suspension part 224, where appropriate.

Referring to FIG. 6, the first suspension part 222 may be formed as a single monolithic component. For example, the first suspension part 222 may be 3D (three-dimensional) printed or milled, cut, or otherwise formed from a single block of material. In this manner, the first plate 228, second plate 230, and resilient members 214 may be formed monolithically from the same material. In other examples, each component may be formed separately and attached together (e.g., using fasteners, welding, or other techniques). In examples, the first plate 228 may be configured for coupling to guide wheel 204, such as the first plate 228 including a cutout 602 to accommodate the axle 258 of the guide wheel 204.

The second plate 230 may extend around the first plate 228, such as to define a space 604 between the first plate 228 and the second plate 230. The resilient members 214 may allow the movement 216 of the first plate 228 within the space 604. For instance, the resilient members 214 may bend, twist, flex, or otherwise deform to allow movement 216 of the first plate 228 towards or away from the second plate 230. The resilient members 214 may extend within the space 604 between the first and second plates 228, 230. For example, the first plate 228 may include opposing first and second sides 608, 610, and opposing third and fourth sides 612, 614. The resilient members 214 may extend on opposite sides of the first plate 228, such as to connect the third and fourth sides 612, 614 to the second plate 230. In such implementations, the resilient members 214 may resiliently deform to allow movement 216 of the first side 608 or second side 610 towards or away from the second plate 230 (e.g., to reduce or enlarge the space 604 or distance between the first side 608 and the second plate 230, or to reduce or enlarge the space 604 or distance between the second side 610 and the second plate 230).

The position and/or shape of the resilient members 214 may provide a linear movement of the first plate 228 relative to the second plate 230. For example, the resilient members 214 may resiliently deform to allow movement of the first side 608 or second side 610 towards or away from the second plate 230, while also limiting movement of the third side 612 or fourth side 614 towards or away from the second plate 230 (e.g., to maintain the space 604 or distance between the third side 612 and the second plate 230, or the space 604 or distance between the fourth side 614 and the second plate 230, during movement of the first plate 228). In this manner, the resilient members 214 may constrain movement (e.g., movement 216) of the guide wheel 204 to perpendicular or near perpendicular to the track 104 or rail 200. For example, the resilient members 214 may extend parallel to one another to define a parallel beam configuration that constrains movement of the first plate 228 to a direction perpendicular to the track 104, although other configurations are contemplated.

In some examples, an engagement of the first plate 228 with the second plate 230 may define a stop position. For instance, the resilient members 214 may resiliently deform until the first plate 228 engages the second plate 230, whereupon no further movement of the first plate 228 relative to the second plate 230 occurs. The engagement may bottom out the suspension action of the resilient members 214 and define an extent of movement 216 of the first plate 228 relative to the second plate 230. Depending on the application, a spring constant provided by the resilient members 214 may limit or define the engagement of the first plate 228 with the second plate 230 (e.g., to limit a harsh or abrupt engagement). The spring constant may be linear or nonlinear, based on application.

The resilient members 214 may be shaped to provide a desired movement of the first plate 228 relative to the second plate 230. For instance, the resilient members 214 may be relatively thin in thickness (e.g., in a horizontal cross-section) to allow movement 216 of the first plate 228 in the plane of the second plate 230. Conversely, the resilient members 214 may be relatively thick in vertical cross-section to limit movement of the first plate 228 out of the plane. As shown, the resilient members 214 may be formed as parallel beams, although other configurations are contemplated, including torsional springs, linear springs, etc. Additionally, or alternatively, the resilient members 214 may include different shapes and thicknesses to adjust suspension characteristics, change the spring rate, etc., such as to adapt the suspension system 102 to the application.

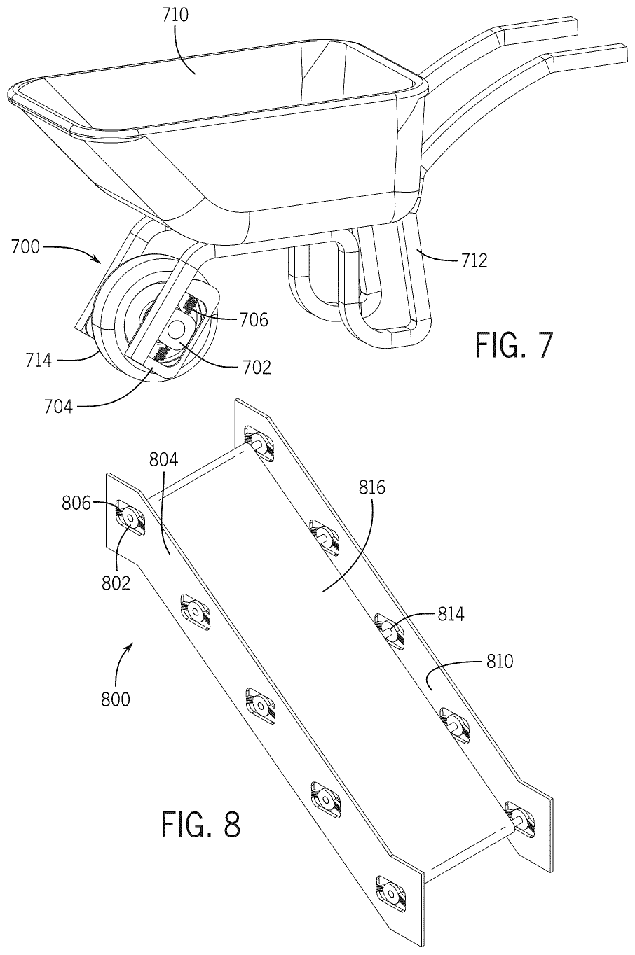

FIG. 7 illustrates another example suspension system 700. Except as otherwise noted below, the suspension system 700 may be similar to the suspension system 100, described above. For example, the suspension system 700 may include a plate 702, a frame 704 extending at least partially around the plate 702, and resilient members 706 extending between to connect the plate 702 to the frame 704.

As shown, the suspension system 700 may be implemented in a wheelbarrow 710. The wheelbarrow 710 includes a chassis 712 and a wheel 714. Although a wheelbarrow is shown, the suspension system 700 may be implemented in other devices or systems having a wheel that traverses along the ground, where a suspension action for the wheel is desired.

The suspension system 700 may be coupled to or otherwise associated with the chassis 712 and wheel 714. For instance, the frame 704 may be coupled to the chassis 712, or the chassis 712 may define at least portions of the frame 704. The plate 702 may be coupled to the wheel 714, such as defining a mounting location for an axle of the wheel 714. The resilient members 706 may resiliently deform to allow movement of the plate 702 relative to the frame 704. For example, the resilient members 706 may bend, flex, stretch, or compress to allow movement of the wheel 714 relative to the chassis 712, such as to provide a suspension action for the wheel 714. In some examples, the frame 704 may define a track for the plate 702, such as to constrain movement of the plate 702 to a desired direction. In such examples, the plate 702 may move along the track against the bias of the resilient members 706.

FIG. 8 illustrates another example suspension system 800. Except as otherwise noted below, the suspension system 800 may be similar to the suspension system 100, described above. For example, the suspension system 800 may include a plate 802, a frame 804 extending at least partially around the plate 802, and resilient members 806 extending between to connect the plate 802 to the frame 804.

As shown, the suspension system 800 may be implemented in a conveyor system 810. The conveyor system 810 includes a plurality of rollers 814 and a belt 816 supported by the rollers 814. Although a conveyor system is shown, the suspension system 800 may be implemented in other devices or systems where a suspension action is desired.

The suspension system 800 may be coupled to or otherwise associated with the rollers 814. For instance, the plate 802 may be coupled to a roller, such as defining a mounting location for an axle of the roller. The resilient members 806 may resiliently deform to allow movement of the plate 802 relative to the frame 804. For example, the resilient members 806 may bend, flex, stretch, or compress to allow movement of the roller relative to the frame 804, such as to provide a suspension action for the belt 816. In some examples, the resilient members 806 may tension the belt 816, such as configured to maintain the belt 816 taught without undesired slack.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A suspension system comprising:
a plate;
a frame extending at least partially around the plate; and
a resilient member extending between to connect the plate to the frame, wherein the resilient member is configured to resiliently deform to allow a movement of the plate relative to the frame.

2. The suspension system of claim 1, wherein the resilient member is configured to bend to allow the movement.

3. The suspension system of claim 1, wherein the resilient member defines a spring constant for the movement.

4. The suspension system of claim 1, wherein the movement is a translational movement of the plate relative to the frame.

5. The suspension system of claim 1, further comprising a second resilient member extending between to connect the plate to the frame, wherein the resilient member and the second resilient member are provided on opposite sides of the plate.

6. The suspension system of claim 1, further comprising a chassis configured to couple a track vehicle to a track, wherein the frame is coupled to the chassis.

7. A suspension part formed as a single monolithic component, the suspension part comprising:
a first plate;
a second plate; and
a resilient member extending between the first plate and the second plate, wherein the resilient member is configured to resiliently deform to allow a movement of the first plate relative to the second plate.

8. The suspension part of claim 7, wherein the first plate and the second plate are coplanar in a plane.

9. The suspension part of claim 8, wherein the resilient member is configured to resiliently deform to allow a movement of the first plate within the plane.

10. The suspension part of claim 9, wherein the resilient member is configured to limit a second movement of the first plate out of the plane.

11. The suspension part of claim 7, wherein the first plate defines a rotation axis for a wheel, and wherein the second plate is configured to be fixed to a chassis.

12. The suspension part of claim 7, wherein an engagement of the first plate with the second plate defines a stop position.

13. A suspension system comprising the suspension part of claim 7, the suspension system further comprising a second suspension part formed as a second single monolithic component, wherein:
the second suspension part comprises a third plate, a fourth plate, and a second resilient member extending between the third plate and the fourth plate; and
the second resilient member is configured to resiliently deform to allow a movement of the third plate relative to the fourth plate.

14. The suspension system of claim 13, further comprising at least one boss coupling the suspension part to the second suspension part, the at least one boss spacing the suspension part from the second suspension part to define a space for receiving a wheel.

15. A suspension system comprising:
a chassis configured to couple a track vehicle to a track;
a pair of plates defining a rotation axis for a wheel configured to traverse along the track;
a frame associated with the chassis and extending adjacent the pair of plates; and
resilient members extending between the pair of plates and the frame, wherein the resilient members are configured to resiliently deform to allow a movement of the pair of plates relative to the frame.

16. The suspension system of claim 15, wherein the frame comprises:
a first frame component coupled to a first plate of the pair of plates;
a second frame component coupled to a second plate of the pair of plates; and
at least one third frame component spacing the first frame component away from the second frame component to define a space for receiving the wheel.

17. The suspension system of claim 16, wherein:
the resilient members comprise a first set of resilient members and a second set of resilient members;
the first set of resilient members extend between the first frame component and the first plate; and
the second set of resilient members extend between the second frame component and the second plate.

18. The suspension system of claim 15, wherein the pair of plates are configured to couple to an axle of the wheel.

19. The suspension system of claim 15, wherein the chassis limits a first movement of the track vehicle relative to the track, and wherein the movement is a second movement perpendicular to the first movement.

20. The suspension system of claim 15, wherein the movement is perpendicular to the rotation axis.
